(19) United States
(12) Patent Application Publication
(10) Pub. No.: US 2013/0080684 A1
(43) Pub. Date: Mar. 28, 2013

(54) ADAPTER HAVING HIGH SPEED STORAGE DEVICE

(71) Applicants: SEUNG HWAN HA, SEOUL (KR); HYUN JIN CHOI, SUWON-SI (KR)

(72) Inventors: SEUNG HWAN HA, SEOUL (KR); HYUN JIN CHOI, SUWON-SI (KR)

(73) Assignee: SAMSUNG ELECTRONICS CO., LTD., SUWON-SI (KR)

(21) Appl. No.: 13/532,818

(22) Filed: Jun. 26, 2012

(30) Foreign Application Priority Data
Sep. 22, 2011 (KR) 10-2011-0095629

(51) Int. Cl. G06F 12/02

(52) U.S. Cl. 711/103; 711/E12.008

(57) ABSTRACT

An adapter, providing a selective connection between a host and mass storage device, includes a high-speed storage device, a host interface and a device interface. The high-speed storage device is provided on a front surface of a printed circuit board (PCB), and includes multiple nonvolatile memory devices and a controller configured to control operations of the nonvolatile memory devices. The host interface is on a back surface of the PCB, and is configured to interface between the high-speed storage device and the host. The device interface is on the back surface of the PCB, and is configured to interface between the high-speed storage device and the mass storage device.

### CROSS-REFERENCE TO RELATED APPLICATIONS

A claim of priority under 35 U.S.C. §119 is made to Korean Patent Application No. 10-2011-095629, filed on Sep. 22, 2011, in the Korean Intellectual Property Office, the entire contents of which are hereby incorporated by reference.

### BACKGROUND OF THE INVENTION

Embodiments of the inventive concept relate to an adapter having a high-speed storage device.

As the information-oriented society has arrived, there has been an explosive increase in the amount of data to be stored or moved. A variety of personal mass storage devices have been developed to meet increasing demand for information storage. Mass storage devices may be connected to a host device in the form of single storage to write or read data in response to commands from the host device.

Hard disk drives (HDDs) are widely used for mass storage, because they provide several technical advantages, such as a high writing density, fast access time, and low cost. However, a hard disk drive generally includes a platter and multiple mechanical parts for operating the platter. As a result, a hard disk drive is somewhat fragile and sensitive to shock.

In order to increase data storage capacity and to improve an operation speed, hybrid storage has been developed, including multiple storage devices. However, when multiple mass storage devices are logically and physically coupled with each other in the hybrid storage, it may be difficult to improve performance of the hybrid storage. Accordingly, there is a need to improve efficiency in resource use and performance of the hybrid storage.

### SUMMARY

Embodiments of the inventive concept provide an adapter with high-speed storage.

According to exemplary embodiments of the inventive concept, an adapter, providing a selective connection between a host and a mass storage device, includes high-speed storage device, a host interface and a device interface. The high-speed storage device is provided on a front surface of a printed circuit board (PCB), and includes multiple nonvolatile memory devices and a controller configured to control operations of the nonvolatile memory devices. The host interface is on a back surface of the PCB, and is configured to interface between the high-speed storage device and the host. The device interface is on the back surface of the PCB, and is configured to interface between the high-speed storage device and the mass storage device.

The nonvolatile memory devices may be NAND FLASH memory devices. Also, the nonvolatile memory devices may include a cache region configured to store data frequently read by the host and a main region configured to store data provided from the host.

The controller may be configured to connect the host with the nonvolatile memory devices via the host interface. Also, the controller may be configured to connect the mass storage device with the nonvolatile memory devices via the device interface.

The host and device interfaces may be configured to transfer data through a Serial Advanced Technology Attachment (SATA) interface. The host interface may include at least one host SATA port connected to the host, and the device interface may include at least one device SATA port connected to the mass storage device.

According to exemplary embodiments of the inventive concept, a user device includes a host, a mass storage device and an adapter having a high-speed storage device. The high-speed storage device includes multiple nonvolatile memory devices and a memory controller configured to control operations of the nonvolatile memory devices, a host interface configured to interface between the high-speed storage device and the host, and a device interface configured to interface between the high-speed storage device and the mass storage device.

The high-speed storage device may have a faster data accessing speed than the mass storage device.

The nonvolatile memory devices may include a cache region configured to store data frequently read by the host, and a main region configured to store data provided from the host. The mass storage device may use the high-speed storage of the adapter as a cache memory.

According to exemplary embodiments of the inventive concept, an adapter, providing a selective connection between a host and a mass storage device, includes a high-speed storage device, a host interface and a device interface. The high-speed storage device includes multiple nonvolatile memory devices and a controller configured to control operations of the nonvolatile memory devices. The host interface is configured to interface between the high-speed storage device and the host. The device interface is configured to interface between the high-speed storage device and the mass storage device. The controller is configured to control one or more of the nonvolatile memory devices to be used as a cache of the mass storage device when the controller senses that the mass storage device is connected to the device interface, and to control one or more of the nonvolatile memory devices to be used as additional storage for the host when the controller senses that the mass storage device is not connected to the device interface.

### BRIEF DESCRIPTION OF THE DRAWINGS

Exemplary embodiments will be more clearly understood from the following detailed description taken in conjunction with the accompanying drawings, in which:

FIG. 1 is a block diagram of a high-speed storage adapter connecting a host and a mass storage device, according to an exemplary embodiment of the inventive concept;

FIGS. 2A and 2B are top and bottom perspective views of a high-speed storage adaptor, respectively, according to exemplary embodiments of the inventive concept;

FIG. 3 is a block diagram of a high-speed storage adaptor, according to an exemplary embodiment of the inventive concept;

FIG. 4 is a perspective view of an illustrative electronic device including the high-speed storage adapter, according to exemplary embodiments of the inventive concept; and

FIG. 5 is a block diagram schematically illustrating a user device including the high-speed storage adapter, according to exemplary embodiments of the inventive concept.

It should be noted that the figures are intended to illustrate general characteristics of the structure, materials and/or methods utilized in certain illustrative embodiments, and to supplement the written description provided below. The figures are not, however, to scale and may not precisely reflect the precise structural or performance characteristics of any given embodiment, and should not be interpreted as defining or limiting the range of values or properties encompassed by exemplary embodiments. For example, the relative sizes and thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. In the drawings, the thicknesses of layers and regions are exaggerated for clarity. Unless otherwise noted, like reference numerals denote like elements throughout the attached drawings and written description, and thus descriptions will not be repeated.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments. Also, the term “exemplary” is intended to refer to an example or illustration.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of exemplary embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Illustrative embodiments of the inventive concept are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, illustrative embodiments should not be construed as limited to the particular shapes of regions illustrated herein, but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of exemplary embodiments.

Unless otherwise defined, all terms (including technical and scientific terms) used herein have the same meaning as commonly understood by one of ordinary skill in the art to which exemplary embodiments of the inventive concept belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

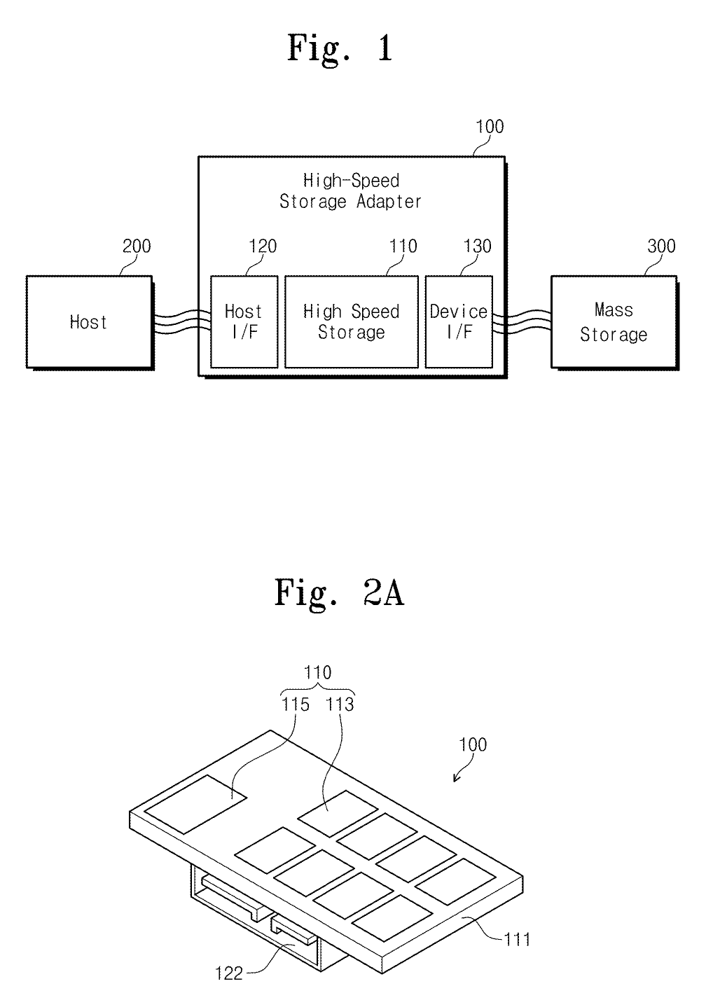

FIG. 1 is a block diagram of an adapter connecting a host and a mass storage device, according to an exemplary embodiment of the inventive concept.

Referring to FIG. 1, high-speed storage adapter 100 includes high-speed storage device 110, host interface (I/F) 120 and device interface (I/F) 130. The adapter 100 is connected to the host 200 via the host interface 120 and is configured to write or read data to or from the high-speed storage device 110 in response to requests from the host 200. Mass storage device 300 is additionally connected to the adapter 100 via the device interface 130. The adapter 100 is therefore able to implement selective connections between the host 200 and the mass storage device 300.

The host 200 provides requests to write data to or read data from the adapter 100 having the high-speed storage device 110. Further, the host 200 may provide requests to write data to or read data from the mass storage device 300 via the adapter 100. The host 200 may be a data processing device, such as a personal computer (PC), a notebook computer, an Ultra Mobile PC (UMPC), a workstation, a net-book, a personal digital assistant (PDA), a web tablet, a wireless phone, a mobile phone, a smart phone, an e-book, a portable multimedia player (PMP), a digital camera, a digital audio recorder/player, a digital picture/video recorder/player, a portable game machine, a navigation system, a black box, a three-dimensional television, a digital audio recorder, or a digital audio player, for example.

The mass storage device 300, connected to the host 200 via the adapter 100, may be configured to provide extra data storage for the host 200. The mass storage device 300 executes tasks requested from the host 200. For example, the mass storage device 300 may be configured to write or read data in response to requests from the host 200. In various embodiments, the mass storage device 300 may be a large capacity hard disk drive (HDD), exhibiting a slow operating speed. In other embodiments, the mass storage device 300 may be a solid state drive (SSD), a digital versatile disc (DVD) or a blue-ray disc (BD), for example.

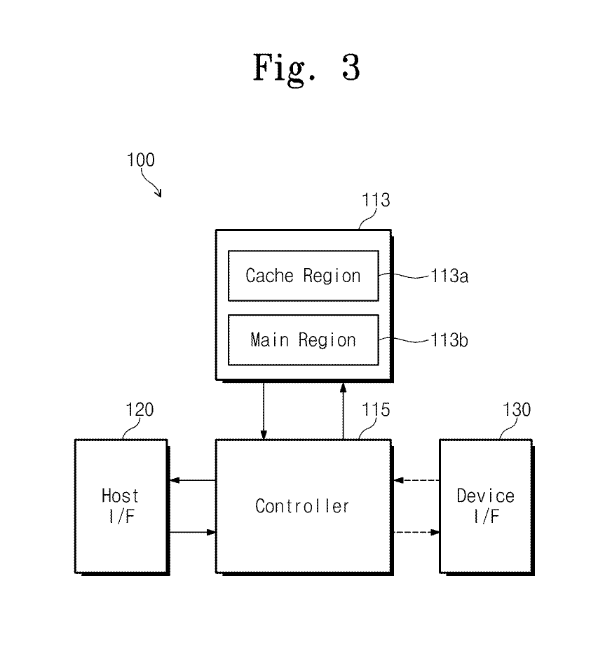

The high-speed storage device 110 may include one or more nonvolatile memory devices and a memory controller, for example. The high-speed storage device 110 exchanges data with the host 200 via the host interface 120, and is configured to read data from or write data to the nonvolatile memory devices in response to read or write requests from the host 200. The nonvolatile memory devices may be memory devices having electrically erasable and programmable properties and nonvolatile properties, for example. In various embodiments, the nonvolatile memory devices may be NAND FLASH memory devices having a large storage capacities and high operating speeds, for example. For purposes of explanation, it is assumed that the nonvolatile memory devices are NAND FLASH memory devices, but other types of nonvolatile memory devices, such as phase-change random access memories (PRAMs), magnetic RAMs (MRAMs), resistive RAMs (ReRAMs), ferroelectric RAMs (FRAMs), or NOR FLASH memory devices, may be included without departing from the scope of the present teachings. Further, the high-speed storage device 110 may include nonvolatile memory devices that are different from each other, or may include volatile memory devices, such as dynamic RAMs (DRAMs) or static RAMs (SRAMs). The high-speed storage device 110 will be described in more detail with reference to FIG. 3.

In various embodiments, the host interface 120 and the device interface 130 may be configured to interface with computer bus standards, storage bus standards, iFCP Peripheral bus standards, or a combination of two or more standards. The computer bus standards may include, for example, S-100 bus, Mbus, Smbus, Q-Bus, ISA, Zorro II, Zorro III, CAMAC, FASTBUS, LPC, EISA, VME, VXI, NuBus, TURBOchannel, MCA, Sbus, VLB, PCI, PXI, HP GSC bus, CoreConnect, InfiniBand, UPA, PCI-X, AGP, PCIe, Intel QuickPath Interconnect, Hyper Transport, and the like. The storage bus standards may include, for example, ST-506, Enhanced Small Disk Interface (ESDI), Storage Module Device (SMD), Parallel Advanced Technology Attachment (PATA), DMA, SSA, HIPPI, Universal Serial Bus (USB), USB Mass Storage (USB MSC), FireWire 1394, Serial ATA (SATA), eSATA, Small Computer System Interface (SCSI), Parallel SCSI, Serial Attached SCSI, iSCSI, SAS, RapidIO, Fibre Channel, Fibre Channel over IP (FCIP), and the like. The iFCP Peripheral bus standards may include, for example, Apple Desktop Bus, HIL, MIDI, Multibus, RS-232, DMX512-A, EIA/RS-422, IEEE-1284, UNI/O, 1-Wire, I2C, SPI, EIA/RS-485, USB, Camera Link, External PCIe, Light Peak, Multidrop Bus, and the like.

In other embodiments, the host interface 120 and/or the device interface 130 may be configured to enable USB connections or optical port connections. Alternatively, the host interface 120 and/or the device interface 130 may be configured to enable wired or wireless connections.

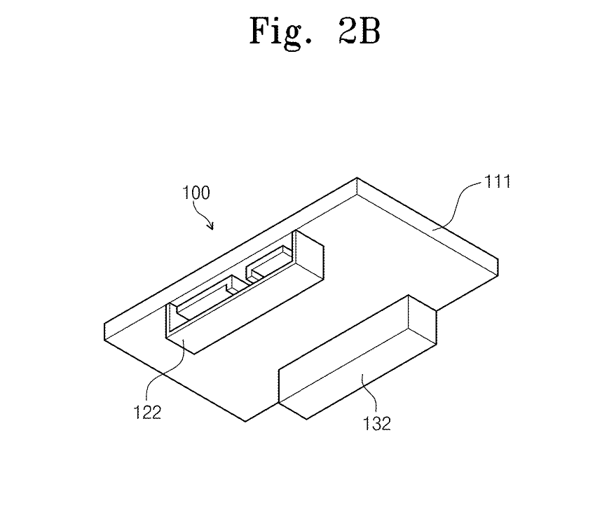

FIGS. 2A and 2B are top and bottom perspective views respectively of a high-speed storage adapter, according to exemplary embodiments of the inventive concept.

Referring to FIGS. 2A and 2B, the adapter 100 includes a printed circuit board (PCB) 111, the high-speed storage device 110, a host port 122 for the host interface 120, and a device port 132 for the device interface 130. The high-speed storage device 110 includes one or more nonvolatile memory devices 113 (e.g., NAND FLASH memory devices) and controller 115 mounted on the PCB 111. In various embodiments, at least one volatile memory device (e.g., DRAM) may be additionally mounted on the PCB 111. In the depicted embodiment, the nonvolatile memory devices 113 and the controller 115 are mounted on the front surface of the PCB 111. However, the nonvolatile memory devices 113 and/or the controller 115 alternatively may be mounted on the back surface or on both of front and back surfaces of PCB 111. The controller 115 controls the nonvolatile memory devices 113.

The nonvolatile memory devices 113 and the controller 115 may be packaged on the PCB 111 in various configurations. For instance, the nonvolatile memory devices 113 and the controller 115 may be employed in a Package on Package (PoP), Ball Grid Array (BGA), Chip Scale Package (CSP), Plastic Leaded Chip Carrier (PLCC), Plastic Dual In-line Package (PDIP), Die in Waffle Pack, Die in Wafer Form, Chip On Board (COB), Ceramic Dual In-line Package (CERDIP), Plastic Metric Quad Flat Pack (MQFP), Thin Quad Flat Pack (TQFP), Small Outline Integrated Circuit (SOIC), Shrink Small Outline Package (SSOP), Thin Small Outline Package (TSOP), System In Package (SIP), Multi Chip Package (MCP), Wafer-level Fabricated Package (WFP), or Wafer-level Processed Stack Package (WSP).

In various embodiments, the host and device ports 122 and 132 of the adapter 100 may be SATA ports, for example, corresponding to the host and device interfaces 120 and 130, respectively. In various embodiments, the host port 122 and the device port 132 are provided on the back surface of the PCB 111, while the nonvolatile memory devices 113 and the controller 115 are provided on the opposite (front) surface of the PCB 111. Of course, the host and device ports 122 and 132 may be provided on the front surface, while the nonvolatile memory devices 113 and the controller 115 may be provided on the opposite (back) surface of the PCB 111, or one or more of the nonvolatile memory devices 113 and the controller 115 may be on the same surface as the host and device ports 122 and 132. Each of the host and device ports 122 and 132 may have at least one data port and at least one power port, for example.

The host 200 may be directly connected to the host port 122, and the mass storage device 300 may be directly, but selectively, connected to the device port 132. When the mass storage device 300 is connected to the device port 132, the controller 115 senses the connection and controls the nonvolatile memory devices 113 to be used as a cache of the mass storage device 300. When the mass storage device 300 is not connected to the adapter 100, the adapter 100 may provide additional storage space for the host 200, allowing faster access. In various embodiments, multiple device ports 132 may be provided on the PCB 111, in which case, multiple mass storage devices 300 may be connected to the adapter 100, respectively, and the nonvolatile memory devices 113 may provide multiple corresponding caches.

FIG. 3 is a block diagram of an adapter having a high-speed storage device, according to an exemplary embodiment of the inventive concept.

Referring to FIG. 3, the high-speed storage device 110 in the adapter 100 includes multiple nonvolatile memory devices, indicated by representative nonvolatile memory device 113, and the controller 115. The nonvolatile memory device 113 is configured to execute operations, such as reading, erasing, programming, and/or merging operations, in response to control signals from the controller 115.

In various embodiments, the nonvolatile memory device 113 may be a NAND FLASH memory device having nonvolatile properties, for example. As a result, the nonvolatile memory device 113 may be used not only as data storage, but also as code storage capable of preserving code data even when power is removed.

The representative nonvolatile memory device 113 may include a cache region 113a and/or a main region 113b. That is, in various embodiments, the nonvolatile memory devices 113 may include a portion serving as the cache region 113a and another portion serving as the main region 113b. In other embodiments, the nonvolatile memory device 113 may be entirely used as one region (the cache region 113a or the main region 113b), while another nonvolatile memory device 113 (not shown in FIG. 3) may be entirely used as the other region (the main region 113b or the cache region 113a).

The cache region 113a stores data that are frequently updated or accessed (“hot” data), and the main region 113b stores data that are seldom (less frequently) updated or accessed (“cold” data). The main region 113b may be configured to store data provided from the host 200, for example. In various embodiments, the cache region 113a may be implemented using at least one nonvolatile memory device (hereinafter, a high-speed nonvolatile memory) exhibiting a high operation speed, and the main region 113b may be implemented using at least one nonvolatile memory device (hereinafter, a low-speed nonvolatile memory) exhibiting a low operation speed.

In various embodiments, the cache region 113a may be implemented using single-level cells configured to store one bit per cell, and the main region 113b may be implemented using multi-level cells configured to store two or more bits per cell. In other embodiments, both the cache region 113a and the main region 113b may be implemented using multi-level cells, in which case the multi-level cells for the cache region 113a may be configured to execute least significant bit (LSB) operations, thereby pretending to be the single-level cells. In still other embodiments, both of the cache region 113a and the main region 113b may be implemented using single-level cells.

The cache region 113a may include a file system, which may be defined as a set of abstract data structures allowing users to hierarchically store, search, access, and control data. For example, the cache region 113a may be configured to include a file allocation table (FAT), a directory entry (DE), and/or an NT File System (NTFS), which may be frequently updated.

In various embodiments, the cache region 113a may be configured to store data that are frequently accessed, and the main region 113b may be configured to provide additional data storage space for the host 200, regardless of the data accessing frequency. A ratio in data storage capacity of the cache region 113a to the main region 113b may be variously changed in the nonvolatile memory devices 113 of the adapter 100. For example, the cache region 113a may have a larger storage capacity than the main region 113b. Alternatively, the cache region 113a may have a smaller storage capacity than the main region 113b.

The controller 115 is configured to connect the host 200 with the nonvolatile memory devices 113 via the host interface 120, and to connect the mass storage device 300 with the nonvolatile memory devices 113 via the device interface 130. In various embodiments, the controller 115 is configured to directly connect the host 200 with the mass storage device 300. For example, data may be directly delivered from the host 200 to the mass storage device 300 via the controller 115, e.g., when the high-speed storage device 110 is in malfunction mode. When the host 200 sends data to be stored in the nonvolatile memory devices 113, the controller 115 controls the file system to write the data in one of the cache region 113a and the main region 113b based on type of the data.

Further, the controller 115 may be configured to conceal a deleting operation of the nonvolatile memory devices 113 during address mapping. For instance, the controller 115 may be configured to implement a FLASH translation layer (FTL). The FTL maps a logical address used by the host 200 to a physical address in the nonvolatile memory devices 113. In addition, the FTL may perform an erase count for a wear leveling operation. Further, the FTL may support a garbage collection operation that collects effective data scattered in blocks of the nonvolatile memory devices 113 and fills the collected data into a single block. The FTL may perform the address mapping, the erase leveling, and the garbage collection in response to writing/reading requests of a File system of the host 200.

Hereinafter, operations of the high-speed storage adapter according to exemplary embodiments of the inventive concept will be described with reference to FIGS. 1, 2A, 2B and 3.

In various embodiments, when data requested from the host 200 is hot data, the controller 115 may write data in or read data from the cache region 113a of one or more nonvolatile memory devices 113. When data requested from the host 200 is the cold data, the controller 115 may write data in or read data from the main region 113b of one or more nonvolatile memory device 113.

In other embodiments, the host 200 may read out data stored in the high-speed storage device 110 of the adapter 100. In this case, the data may be read from the cache region 113a of the nonvolatile memory device 113, for example. The host 200 may write data to the high-speed storage device 110 of the adapter 100. In this case, the data may be written in the main region 113b of the nonvolatile memory device 113, for example.

When the mass storage device 300 is connected to the adapter 100, the controller 115 may store data of the mass storage device 300 in the cache region 113a of the nonvolatile memory device 113 via the device interface 130. Since the cache region 113a is configured to be able to execute a requested operation in a short time, it is possible to reduce data access time, as compared to directly accessing data stored in the mass storage device 300. In other words, the high-speed storage of the adapter 100 may be used as the cache memory of the mass storage device 300, increasing operation speed of the mass storage device 300. When the mass storage device 300 is not connected to the adapter 100, the adapter 100 may provide additional storage space for the host 200, increasing operation speed.

The adapter 100 according to exemplary embodiments of the inventive concept may be applied to a PDA, a portable computer, a web tablet, a wireless phone, a mobile phone, a digital music player, a memory card and/or all the devices that can transmit and/or receive data in a wireless communication environment.

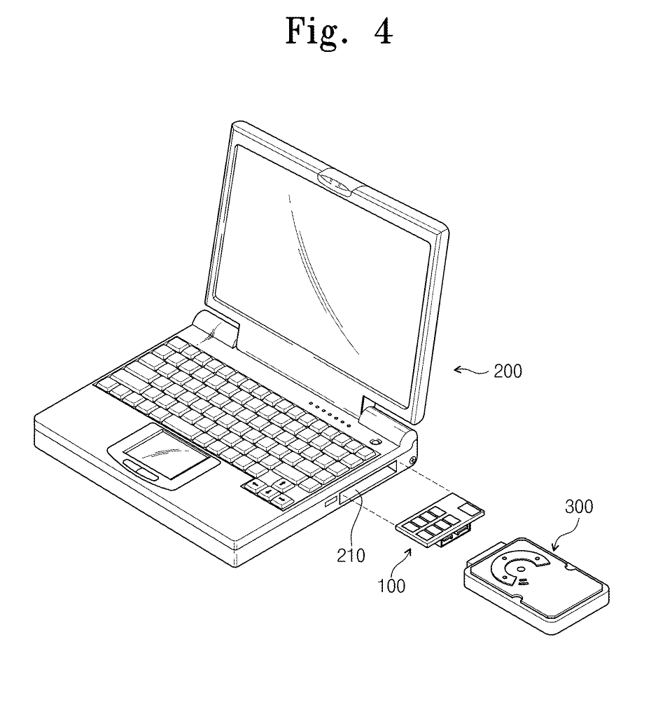

FIG. 4 is a perspective view of an illustrative electronic device including the high-speed storage adapter, according to exemplary embodiments of the inventive concept.

Referring to FIG. 4, the adapter 100 may be included in a portable computer, which serves as host 200 (hereinafter referred to as portable computer 200 with reference to FIG. 4). For example, the portable computer 200 may be configured to have an opening 210 configured for insertion and/or attachment the adapter 100. The portable computer 200 may include a host SATA port (not shown), for example, directly connected to a host SATA port 122 of the adapter 100. Of course, other types of protocols for the host interface may be used without departing from the scope of the present teachings.

The adapter 100 connected to the portable computer 200 may write data in and read data from the high-speed storage device 110 provided in the adapter 100, in response to write/read signals from the portable computer 200. In various embodiments, the mass storage device 300 (for example, a hard disk drive) may be directly connected to the device interface 130 of the adapter 100 without additional cable.

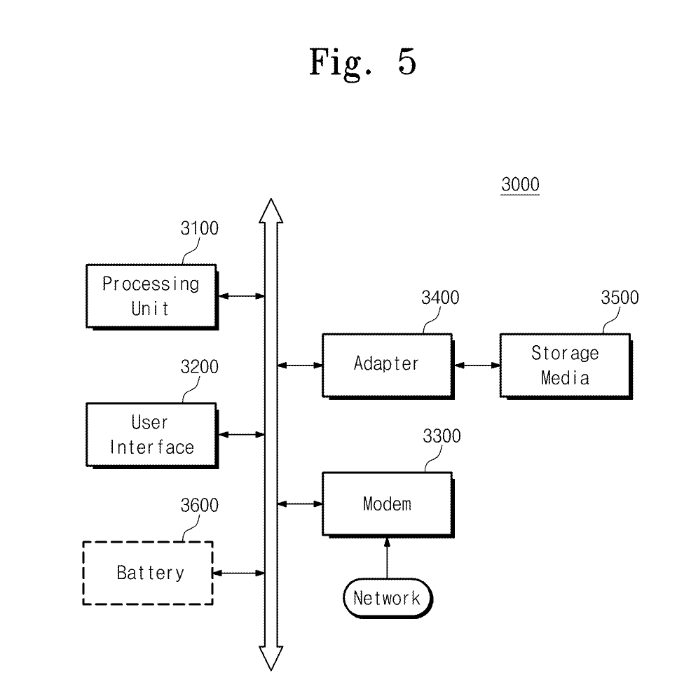

FIG. 5 is a block diagram schematically illustrating a user device including the high-speed storage adapter, according to exemplary embodiments of the inventive concept.

The user device described below may be applied to a PDA, a portable computer, a web tablet, a wireless phone, a mobile phone, a digital music player, a memory card and/or all devices able to transmit and/or receive data in a wireless communication environment, for example.

Referring to FIG. 5, a user device 3000 includes a processing unit 3100 (e.g., a microprocessor), a user interface 3200, a modem 3300 (e.g., a baseband chipset), a high-speed storage adapter 3400, and mass storage media 3500. The high-speed storage adapter 3400 may store data executed by the processing unit 3100. The high-speed storage adapter 3400 may be configured to have substantially the same features as the adapter 100 described with reference to FIGS. 1, 2A, 2B and 3, for example. Due to the presence of the mass storage media 3500, it is possible to provide an additional data storage space for the processing unit 3100.

When the user device 3000 is for mobile use, the user device 3000 may further include a battery 3600 for supplying electric power. Although not depicted in the drawings, it would be apparent to those skilled in the art that other devices, such as an application chipset, a camera image sensor, a camera image signal processor (ISP), an input/output device, or the like, for example, may further be included in the user device 3000, according to exemplary embodiments of the inventive concept.

According to exemplary embodiments of the inventive concept, an adapter with high-speed storage connects a host and a mass storage device. When the adapter is used to connect the host and the mass storage, the adapter may be used as a cache for improving performance of the mass storage. When the mass storage is not connected to the adapter, the adapter may provide additional storage space allowing fast access to the host.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. An adapter providing a selective connection between a host and a mass storage device, the adapter comprising:
a high-speed storage device on a front surface of a printed circuit board (PCB), the high-speed storage device comprising a plurality of nonvolatile memory devices and a controller configured to control operations of the nonvolatile memory devices;
a host interface on a back surface of the PCB, configured to interface between the high-speed storage device and the host; and
a device interface on the back surface of the PCB, configured to interface between the high-speed storage device and the mass storage device.

2. The adapter of claim 1, wherein the nonvolatile memory devices comprise NAND FLASH memory devices.

3. The adapter of claim 1, wherein the nonvolatile memory devices comprise a cache region configured to store data frequently read by the host and a main region configured to store data provided from the host.

4. The adapter of claim 1, wherein the controller is configured to connect the host with the nonvolatile memory devices via the host interface.

5. The adapter of claim 1, wherein the controller is configured to connect the mass storage device with the nonvolatile memory devices via the device interface.

6. The adapter of claim 1, wherein the host and device interfaces are configured to transfer data through a Serial Advanced Technology Attachment (SATA) interface.

7. The adapter of claim 1, wherein the host interface comprises at least one host SATA port connected to the host, and
the device interface comprises at least one device SATA port connected to the mass storage device.

8. A user device, comprising:
a host;
a mass storage device; and
an adapter comprising a high-speed storage device including a plurality of nonvolatile memory devices and a memory controller configured to control operations of the nonvolatile memory devices, a host interface configured to interface between the high-speed storage device and the host, and a device interface configured to interface between the high-speed storage device and the mass storage device.

9. The device of claim 8, wherein the high-speed storage device has a faster data accessing speed than the mass storage device.

10. The device of claim 8, wherein the nonvolatile memory devices include a cache region configured to store data frequently read by the host and a main region configured to store data provided from the host.

11. The device of claim 8, wherein the mass storage device uses the high-speed storage device of the adapter as a cache memory.

12. An adapter providing a selective connection between a host and a mass storage device, the adapter comprising:
a high-speed storage device comprising a plurality of nonvolatile memory devices and a controller configured to control operations of the nonvolatile memory devices;
a host interface configured to interface between the high-speed storage device and the host; and
a device interface configured to interface between the high-speed storage device and the mass storage device,
wherein the controller is configured to control one or more of the nonvolatile memory devices to be used as a cache of the mass storage device when the controller senses that the mass storage device is connected to the device interface, and to control one or more of the nonvolatile memory devices to be used as additional storage for the host when the controller senses that the mass storage device is not connected to the device interface.

13. The adapter of claim 12, wherein at least one of the nonvolatile memory devices comprises a cache region for storing data that are frequently updated or accessed and a main region for storing data that are not frequently updated or accessed.

14. The adapter of claim 12, wherein at least one of the nonvolatile memory devices comprises a cache region for storing data that are frequently updated or accessed and at least one other of the nonvolatile memory devices comprise a main region for storing data that are not frequently updated or accessed.

15. The adapter of claim 14, wherein the cache region comprises single-level cells configured to store one bit per cell.

16. The adapter of claim 15, wherein the main region comprises multi-level cells configured to store two or more bits per cell.

17. The adapter of claim 12, wherein the nonvolatile memory devices comprise NAND FLASH memory devices, and the controller is further configured to implement a FLASH translation layer (FTL).

18. The adapter of claim 12, further comprising:
a printed circuit board (PCB), to which the plurality of nonvolatile memory devices, the controller, a host port for the host interface, and a device port for the device interface are mounted.

19. The adapter of claim 18, wherein the plurality of nonvolatile memory devices and the controller are mounted to one surface of the PCB, and the host and device ports are mounted to an opposite surface of the PCB.

20. The adapter of claim 19, wherein each of the host and device ports are Serial Advanced Technology Attachment (SATA) ports.
